(19) United States
(12) Patent Application Publication
(10) Pub. No.: US 2025/0059986 A1
(43) Pub. Date: Feb. 20, 2025

(54) METHODS AND SYSTEM FOR MITIGATING HYDRAULIC SYSTEM SENSOR DEGRADATION

(71) Applicant: Dana Automotive Systems Group, LLC, Maumee, OH (US)

(72) Inventors: Aaron SHORT, Burbage (GB); Ian MORRISH, Redditch (GB)

(21) Appl. No.: 18/449,403

(22) Filed: Aug. 14, 2023

(51) Int. Cl. F15B 1/04; E02F 9/22

(52) U.S. Cl. CPC F15B 1/04; E02F 9/2235; F15B 2201/51

(57) ABSTRACT

Methods and systems for operating a hydraulic system that includes an electrically driven pump, accumulator, and hydraulic actuators are described. In one example, if degradation of a pressure sensor is present, pressure in the accumulator is estimated based on a volume of the accumulator and/or an amount of electric current that is supplied to an electrically driven pump.

### TECHNICAL FIELD

The present description relates generally to methods and a system for mitigating hydraulic system sensor degradation. The methods and systems may be applied to continue operation of a hydraulic system after sensor degradation has been determined.

### BACKGROUND/SUMMARY

A vehicle or machine may include a hydraulic system to operate actuators and make the vehicle or machine function to perform tasks. For example, an excavator may include a plurality of hydraulic actuators to move a bucket, adjust a position of a boom, and adjust a position of an arm. The hydraulic system may charge an accumulator so that during conditions of high hydraulic demand, the system may maintain a desired level of operation. The accumulator may be charged to a higher pressure via a pump and operation of the pump may be adjusted according to a pressure sensor that provides an indication of pressure in the accumulator. However, the vehicle or machine may work in challenging environments where it may be possible for the pressure sensor to degrade. For example, it may be possible for a wire that supplies electric power to the sensor to become degraded. As a result, the pressure sensor may enter a degraded state where output of the pressure sensor may not accurately represent pressure in the accumulator and hydraulic system. As such, the vehicle or machine may be shut down immediately to reduce a possibility of unintentional operation of the vehicle or machine.

The inventors herein have recognized the above-mentioned issues and have developed a method for operating a system that includes an array of sensors, comprising: adjusting operation of a pump in response to output of a pressure sensor that indicates pressure in an accumulator; and adjusting operation of the pump in response to an amount of electric current delivered to the pump and an indication of degradation of the pressure sensor.

By adjusting operation of an electrically driven pump in response to an amount of electric current delivered to the electrically driven pump when a pressure sensor is degraded, it may be possible to provide the technical result of being able to continue operating the vehicle or machine in an expected way. In particular, pressure in the vehicle's or in the machine's accumulator may be estimated according to an amount of current that is drawn by an electrically driven pump. Accordingly, the vehicle or machine may continue to operate with its hydraulic system in a feedback control mode.

The present description may provide several advantages. In particular, the approach may allow a hydraulic system of a vehicle or machine to continue operating so that the vehicle or machine may be shut down in an orderly way. Further, the approach allows the system to continue to operate with no or minor operating constraints even though pressure sensor degradation is present. In addition, the approach may be implemented without excessive financial expense.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows a machine that includes a hydraulic system;

FIG. 1B shows an alternative machine (a transmission) that includes a hydraulic system;

FIG. 2 is a schematic diagram of a control system for the example vehicle or machine;

FIG. 3 shows a detailed view of an example hydraulic system for a machine;

FIG. 4 shows an example relationship between hydraulic pump torque and pressure in an accumulator of a hydraulic system;

FIG. 5 shows an example operating sequence of a hydraulic system according to the method of FIG. 6;

FIG. 6 shows a flowchart of an example method for operating a hydraulic system of a vehicle or machine;

FIG. 7 is a plot of a relationship between volume of a fluid stored in a hydraulic accumulator and a pressure of the fluid stored in the hydraulic accumulator; and

FIG. 8 is a plot that shows a relationship between electrically driven pump current and pump torque.

### DETAILED DESCRIPTION

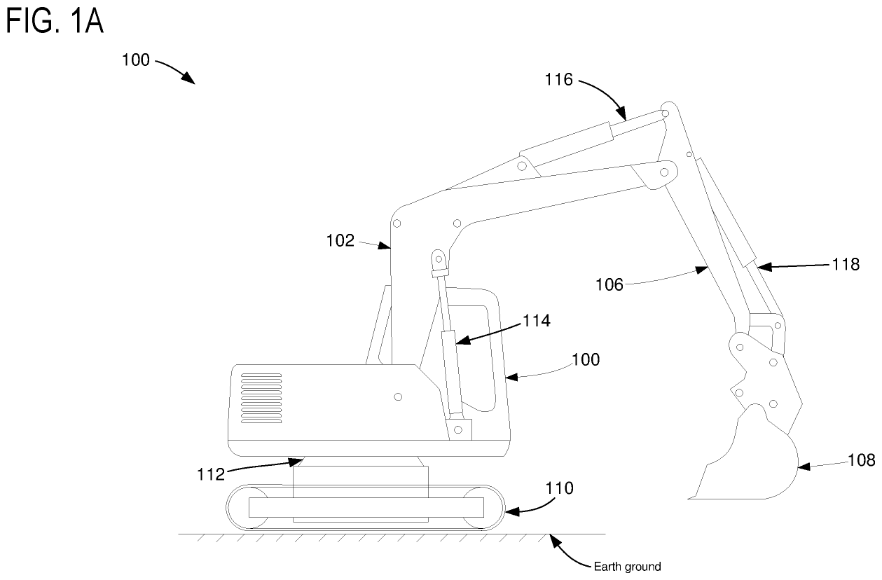

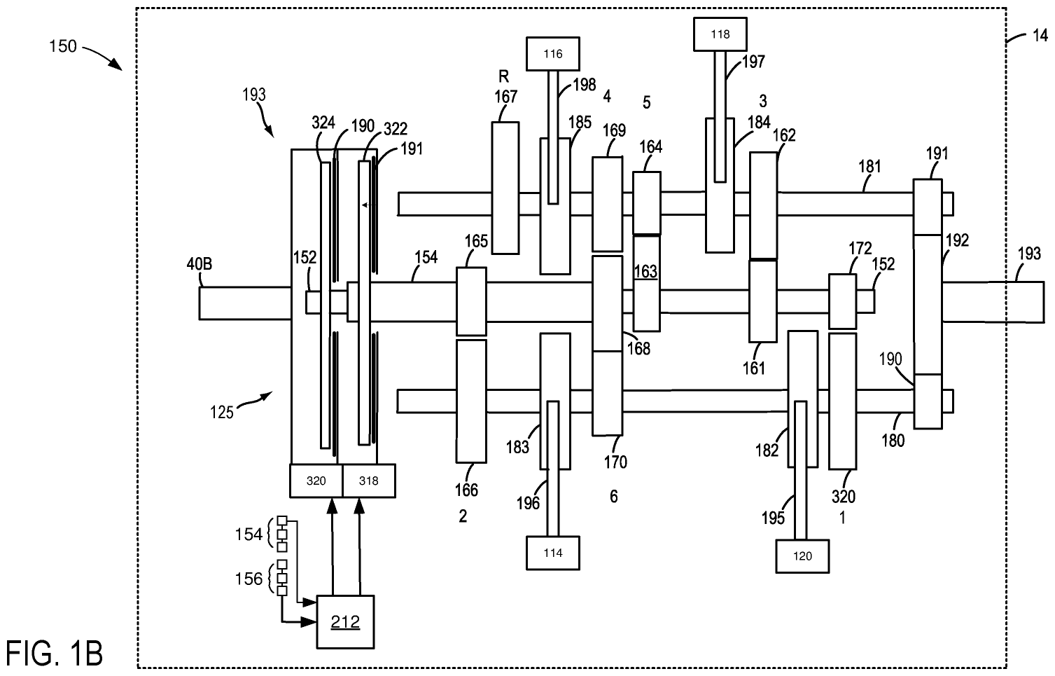

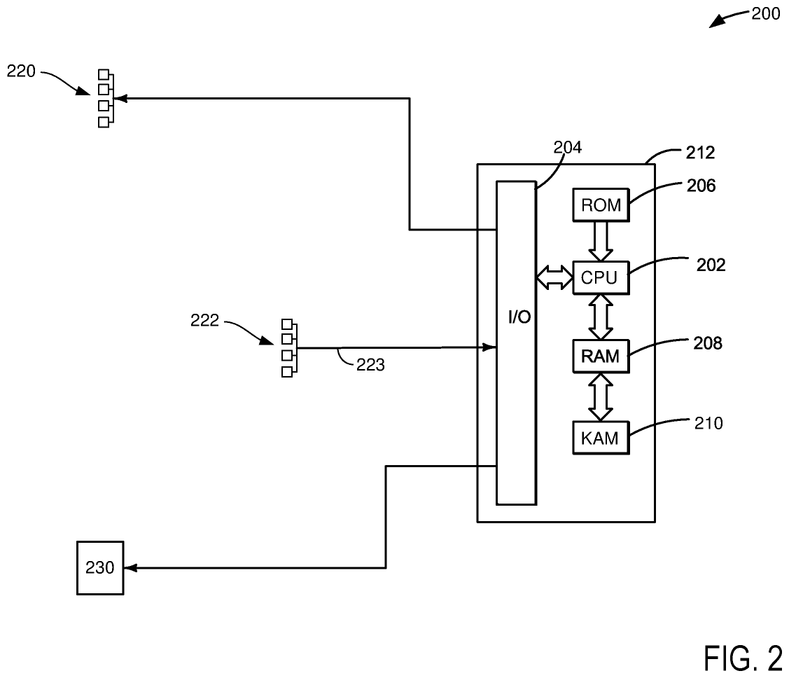

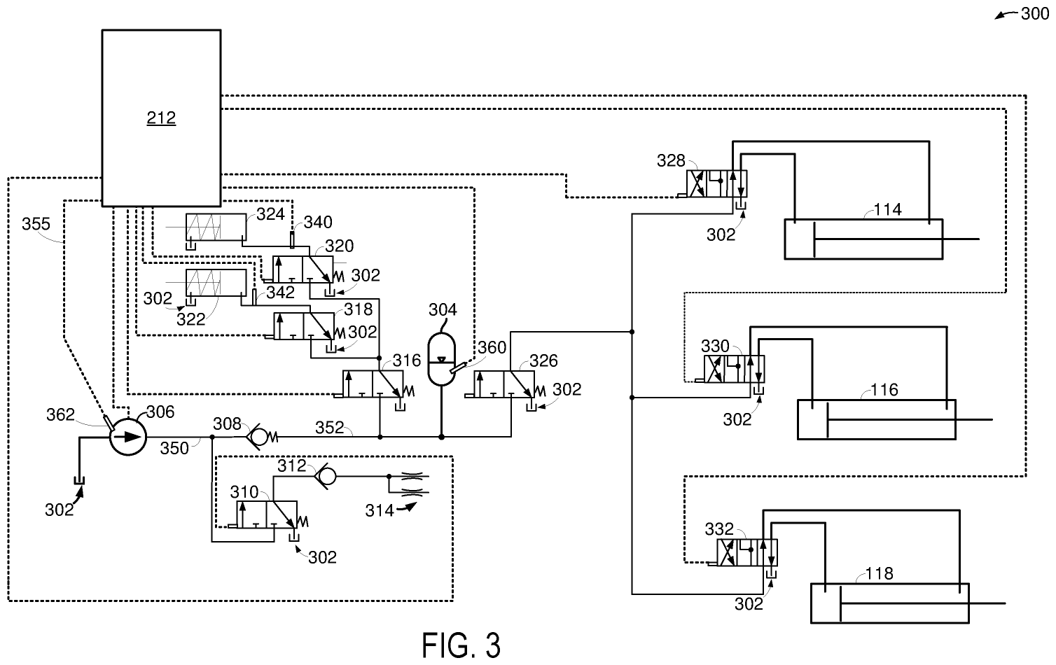

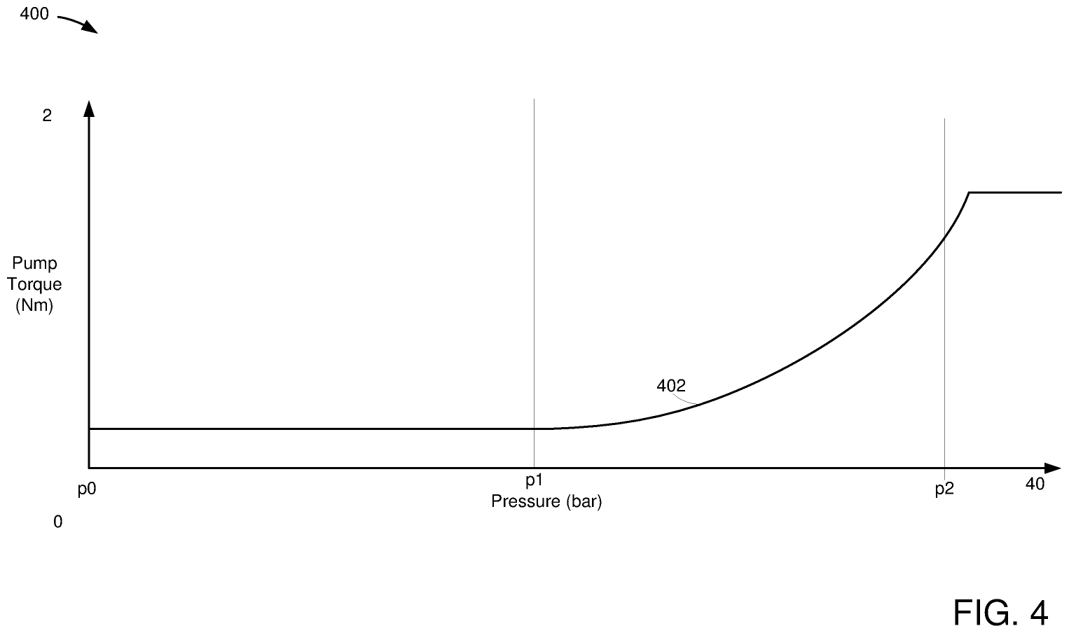

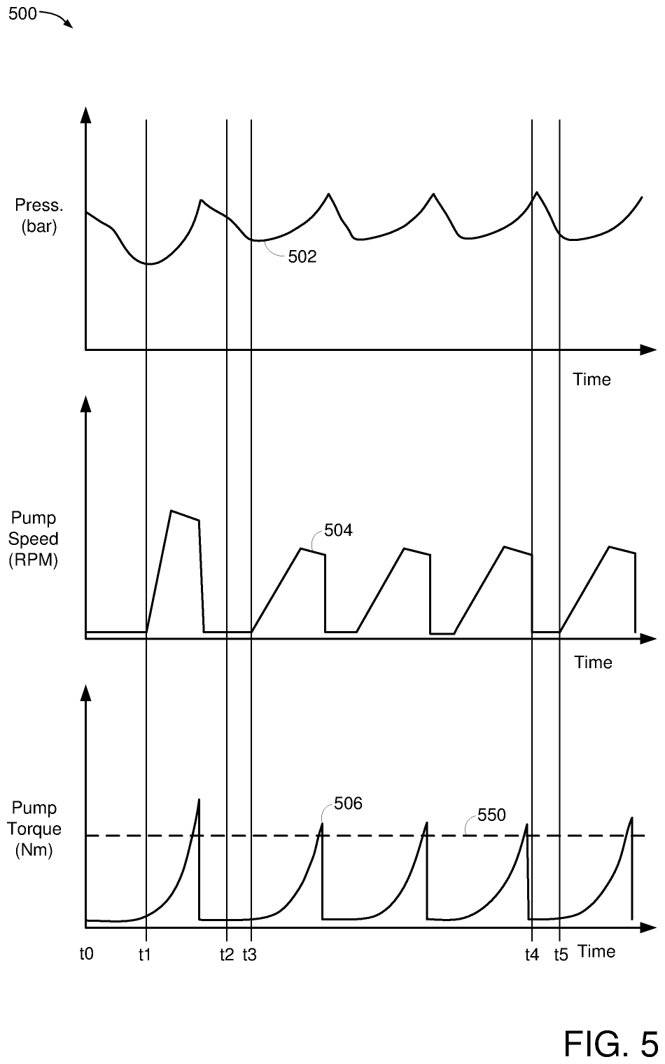

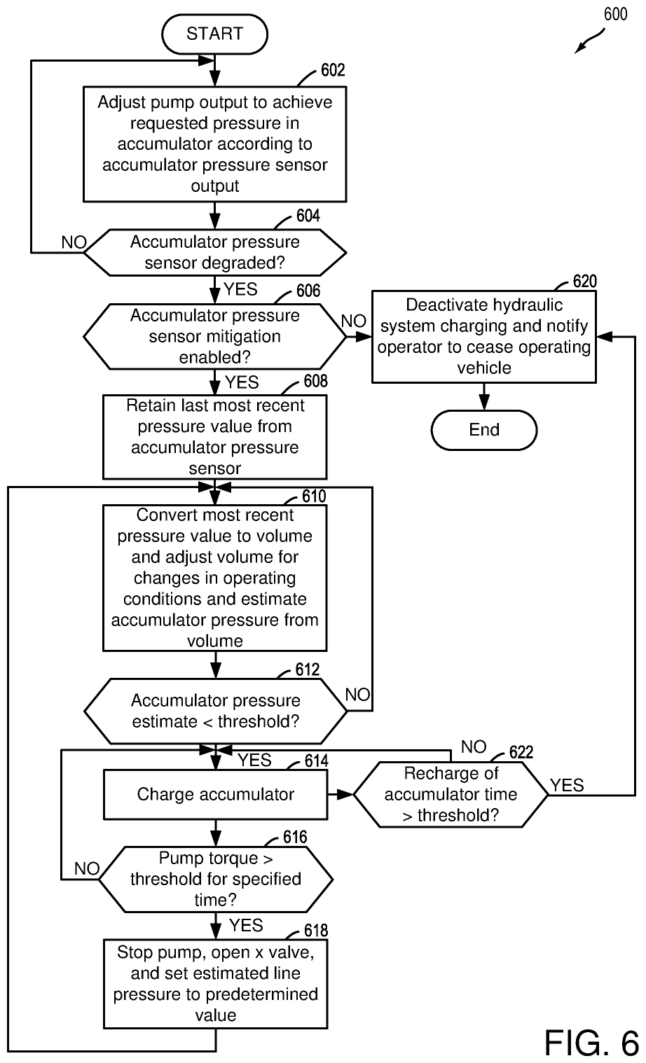

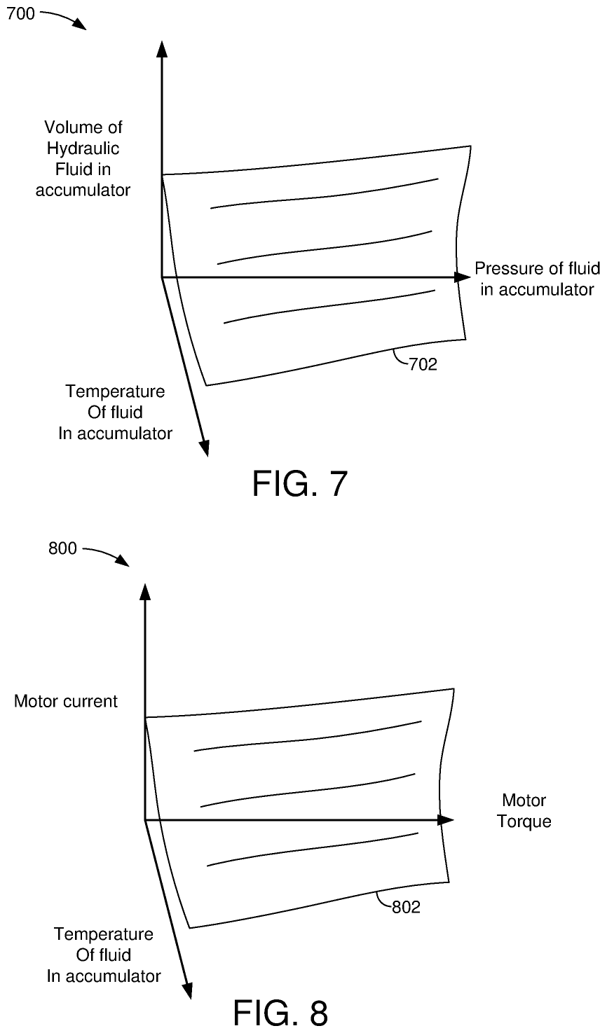

The following description relates to systems and methods for operating a hydraulic system of a machine or vehicle. The system and method operate based on feedback of a pressure sensor when the pressure sensor is not degraded. If the pressure sensor is degraded, the system may continue to operate according to a pressure estimate that is based on a volume of a fluid that is stored in an accumulator or an amount of electric current that is consumed by an electrically driven pump. The method and system may be applied to a vehicle or a machine as shown in FIGS. 1A and 1B. The system and method may utilize a controller of the type shown in FIG. 2. The system and method may operate a hydraulic system as shown in FIG. 3. The system and method may estimate pressure in a hydraulic system according to a relationship as shown in FIG. 4. The system and method may operate as shown in the sequence of FIG. 5 according to the method of FIG. 6. FIGS. 7 and 8 shows relationships that may be applied via the method of FIG. 6 and the system of FIGS. 1-3.

FIG. 1A shows a view of an example machine that includes a hydraulic system. However, it may be appreciated that the system and methods described herein are not limited to the type of machine shown in FIG. 1A. Rather, the system and method described herein may be applied to other machines, mechanisms, or vehicles such as, but not limited to cranes, backhoes, motor graders, crawlers, scrapers, etc. Further, the method and system described herein may be applied to systems with sensors at other locations than are shown in FIG. 1A.

FIG. 1A illustrates an example machine 100 that includes a plurality of hydraulic actuators that may be applied to operate machine 100. In this example, machine 100 includes a cab 100 that is coupled to a propulsion device 110 (e.g., a drive track). Cab 100 may rotate about the drive track 110 via swing gear 112. Boom 102 is coupled to cab 100 and it may move relative to cab 100 via hydraulic cylinder 114. An arm 106 is coupled to the boom 102 such that the arm 106 may pivot about the boom 102. Hydraulic cylinder 116 may extend or retract to cause arm 106 to pivot about boom 102. A tool 108 (e.g., a bucket) is coupled to arm 106 and the tool 108 may pivot about the arm 106. Hydraulic cylinder 118 may be extended and retracted to cause tool 108 to pivot about arm 106. The direction of power delivery is from the cab 100 to the tool 108 via the various coupled components (e.g., boom, artic, arm, and tool). Thus, cab 100 is upstream of tool 108 according to the direction of power delivery of the system.

Referring now to FIG. 1B, an example of a second machine 150 (e.g., a transmission), an alternative machine, that may be part of a system and operated according to the method of FIG. 4. FIG. 1B shows a detailed illustration of an example dual clutch transmission (DCT). An engine crankshaft 40B is illustrated as being coupled to a clutch housing 193. Alternatively, a shaft may couple engine crankshaft 40B to clutch housing 193. Clutch housing 193 may spin in accordance with rotation of crankshaft 40B. Clutch housing 193 may include a first clutch 324 and a second clutch 322. Furthermore, each of first clutch 324 and second clutch 322 have an associated first clutch plate 190, and a second clutch plate 191, respectively. In some examples, the clutches may comprise wet clutches, bathed in oil (for cooling), or dry plate clutches. Engine torque may be transferred from clutch housing 193 to either first clutch 324 or second clutch 322. First transmission clutch 324 transfers torque between a propulsion source (not shown) and first transmission input shaft 152. Second transmission clutch 322 transfers torque between the propulsion source (not shown) and second transmission input shaft 154.

The second machine 150 may include a plurality of gears, as discussed above. In this example, there are two transmission input shafts, including first transmission input shaft 152, and second transmission input shaft 154. Second transmission input shaft 154 is hollow, while first transmission input shaft 152 is solid, and it sits coaxially within the second transmission input shaft 154. As an example, first transmission input shaft 152 may have a plurality of fixed gears. For example, first transmission input shaft 152 may include first fixed gear 172 for receiving first gear 160, and third fixed gear 161 for receiving third gear 162, fifth fixed gear 163 for receiving fifth gear 164. In other words, first transmission input shaft 152 may be selectively coupled to a plurality of odd numbered gears. Second transmission input shaft 154 may include second fixed gear 165 for receiving second gear 166, or a reverse gear 167, and may further include fourth fixed gear 168, for receiving either fourth gear 169 or sixth gear 170. It may be understood that both first transmission input shaft 152 and second transmission input shaft 154 may be connected to each of first clutch 324 and second clutch 322 via spines (not shown) on the outside of each shaft, respectively. In a normal resting state, each of first clutch 324 and second clutch 322 are held open, for example via springs (not shown), etc., such that no torque from a propulsion source may be transmitted to first transmission input shaft 152 or second transmission input shaft 154 when each of the respective clutches are in an open state. Responsive to closing first clutch 324, propulsion source torque may be transmitted to first transmission input shaft 152, and responsive to closing second clutch 322, propulsion source torque may be transmitted to second transmission input shaft 154. During normal operation, controller 212 may ensure that solely one clutch is fully closed at any given time.

Second machine 150 may further include a first layshaft shaft 180, and second layshaft shaft 181. Gears on first layshaft shaft 180 and second layshaft shaft 181 are not fixed, but may freely rotate. In example DCT 150, first layshaft shaft 180 includes first gear 160, second gear 166, and sixth gear 170. Second layshaft shaft 181 includes third gear 162, fourth gear 169, fifth gear 164, and reverse gear 167. First layshaft shaft 180 may transfer torque via a first output pinion 190 and second layshaft shaft 181 may transfer torque via a second output pinion 191. The first output pinion 190 and the second output pinion 191 may transfer torque to gear 192. In this way, both layshafts may transfer torque via each of first output pinion 190 and second output pinion 191, to output shaft 193, where the output shaft 193 may transfer torque to a differential (not shown) which may enable each of the driven wheels of a vehicle to rotate at different speeds, for example when performing turning maneuvers.

As discussed above, each of first gear 160, second gear 166, third gear 162, fourth gear 169, fifth gear 164, sixth gear 170, and reverse gear 167 are not fixed to layshafts, but instead may freely rotate. As such, sleeves including synchronizers may be utilized to enable each of the gears to match the speed of the layshafts, and may further be utilized to lock the gears. In example DCT 150, four sleeves including synchronizers are illustrated, for example, first synchronizer 182, second synchronizer 183, third synchronizer 184, and fourth synchronizer 185. First synchronizer 182 includes corresponding first selector fork 195, second synchronizer 183 includes corresponding selector fork 196, third synchronizer 184 includes corresponding third selector fork 197, and fourth synchronizer 185 includes corresponding fourth selector fork 198. Each of the selector forks may enable movement of each corresponding sleeve and synchronizer to lock one or more gears to a layshaft, or to unlock one or more gears from a layshaft. For example, first synchronizer 182 may be utilized to lock first gear 160. Second synchronizer 183 may be utilized to lock either second gear 166 or sixth gear 170. Third synchronizer 184 may be utilized to lock either third gear 162 or fifth gear 164. Fourth synchronizer 185 may be utilized to lock either fifth gear 169, or reverse gear 167. In each case, movement of the synchronizers may be accomplished via the selector forks (e.g. 195, 196, 197, and 198) moving each of the respective synchronizers to the desired position via actuators (e.g., hydraulic cylinders) 114-120.

Movement of synchronizers via selector forks may be carried out via controller 212 and shift fork actuators (cylinders) 114-120. Controller 212 may collect input signals from various sensors, assess the input, and control various actuators accordingly. Inputs utilized by transmission controller may include but are not limited to transmission range (P/R/N/D/S/L, etc.), vehicle speed, ambient temperature, brake inputs, and gear box input shaft speed (for both first transmission input shaft 152 and second transmission input shaft 154. The controller 212 may control actuators via an open-loop control, or closed-loop control, and adaptive control. For example, adaptive control may enable controller 212 to identify and adapt to clutch engagement points, clutch friction coefficients, and position of synchronizer assemblies.

Second machine 150 may be understood to function as described herein. For example, when first clutch 324 is actuated closed via actuator 320, engine torque may be supplied to first transmission input shaft 152. When first clutch 324 is closed, it may be understood that second clutch 322 is open, and vice versa. Depending on which gear is locked when first clutch 248 is closed, power may be transmitted via the first transmission input shaft 152 to either first layshaft 180 or second layshaft 181, and may be further transmitted to output shaft 193 via either first pinion gear 190 or second pinion gear 191. Alternatively, when second clutch 322 is closed via actuator 318, power may be transmitted via the second transmission input shaft 154 to either first layshaft 180 or second layshaft 181, depending on which gear is locked, and may be further transmitted to output shaft 193 via either first pinion gear 190 or second pinion gear 191. It may be understood that when torque is being transferred to one layshaft (e.g. first output shaft 180), the other layshaft (e.g. second output shaft 181) may continue to rotate even though only the one shaft is driven directly by the input. More specifically, the non-engaged shaft (e.g. second layshaft 181) may continue to rotate as it is driven indirectly by the output shaft 193 and respective pinion gear (e.g. 191).

Referring now to FIG. 2, an example control system 200 for machine 100 is shown. Controller 212 may be in electrical communication with actuators 220 and sensors 222. The actuators 220 may include valves that supply fluid (e.g., oil) to hydraulic cylinders as shown in FIGS. 1A and 1B, hydraulic pressure control valves to control the hydraulic cylinders, electric machines (e.g., motors), electrically driven pumps, etcetera that may adjust operating states of machine 100. The sensors may include but are not limited to pressure sensors, temperature, ambient air temperature sensors, flow sensors, etc. Controller 212 may receive data from and supply data to human/machine interface 230 (e.g., a touch panel or display).

Controller 12 may include a processor 202, read-only memory (non-transitory memory) 206, random access memory 208, and inputs/outputs 205 (e.g., digital inputs, digital outputs, analog inputs, analog outputs, counters/timers, and communications ports). Controller 12 may communicate with sensors 222 via a controller area network or dedicated wires. Further, controller 12 may communicate with actuators 220 via controller area network 223 via dedicated output channels as shown in FIG. 2.

Referring now to FIG. 3, a schematic for a portion of a hydraulic system of machine 100, or alternatively machine 150, is shown. In FIG. 3, devices and hydraulic lines are indicated via solid lines. Electrical connections (e.g., wires) are indicated by dashed lines.

Hydraulic system 300 includes a sump 302 where a supply of fluid is stored. In order to reduce the number of hydraulic connections, sump 302 is also near hydraulic control valves where appropriate. Electrically driven pump 306 may supply fluid from sump 302 to hydraulic actuators (e.g., clutches and cylinders) as well as gears (not shown). In particular, electrically driven pump supplies gears fluid via orifices 314 when charging valve 310 is in an open position. Charging valve 310 is a two position valve that is shown in its closed position where flow from electrically driven pump 306 to orifices 314 by way of conduit 350 is prevented. Closing charge valve 310 allows fluid to flow from electrically driven pump and through check valve 308 such that the fluid may fill accumulator 304 so that a closing force within check valve 308 may be overcome. On the other hand, when charging valve 310 is open, fluid follows a path of least resistance through charging valve 310 and check valve 312 to orifices 314 such that the closing force of check valve 308 is not overcome.

Fluid flowing in conduit 352 may flow to one or more of clutches (e.g., 322 and 324), accumulator 304, and/or one or more cylinders (e.g., 114-118). Hydraulic control valve 316 is a normally closed valve that may control flow of fluid to clutch hydraulic control valve 318 and clutch hydraulic control valve 320. Line pressure at clutch 324 may be monitored via pressure sensor 340. Line pressure at clutch 322 may be monitored via pressure sensor 342. Hydraulic control valve 320 provides individual control of clutch 324. Hydraulic control valve 318 provides individual control of clutch 322.

Hydraulic control valve 326 is also a two position normally closed valve that may control flow of fluid to cylinder hydraulic control valve 328, cylinder hydraulic control valve 330, and cylinder hydraulic control valve 332. Cylinder hydraulic control valve 328 provides individual control of cylinder 114. Cylinder hydraulic control valve 330 provides individual control of cylinder 116. Cylinder hydraulic control valve 332 provides individual control of cylinder 118. Cylinder hydraulic control valves may be adjusted to provide bidirectional control of cylinders 114-116. Controller 212 may adjust the positions of the hydraulic valves, the speed of the electrically driven pump, and monitor the various pressures in the system.

In one example, electrically driven pump 306 includes an electric current sensor 362 to determine an amount of electric current that is consumed via the electrically driven pump 306. Electrically driven pump 306 may communicate an electric current amount or an amount of torque that is generated by the electrically driven pump 306 via a controller area network (CAN) bus 355 or other communication means. Pressure in accumulator 304 may be sensed via sensor 360 and communicated to controller 212.

Thus, the system of FIGS. 1A-3 provides for a hydraulic system, comprising: one or more hydraulic actuators; an electrically driven pump; an accumulator, the accumulator hydraulically selectively coupled to the one or more hydraulic actuators and the electrically driven pump; a pressure sensor; and a controller including a non-transitory computer readable medium having executable instructions that cause the controller to adjust operation of the electrically driven pump in response to output of the pressure sensor during a first condition and adjust operation of the electrically driven pump in response to a pressure estimate based on a volume model for the accumulator during a second condition. In a first example, the system includes where the first condition is where the pressure sensor is not degraded, and where the second condition is where the pressure sensor is degraded. In a second example that may include the first example, the system includes where the volume model includes a fixed volume decay rate. In a third example that may include one or both of the first and second examples, the system further comprises one or more hydraulic actuators, and where the volume model compensates for actuation of one or more hydraulic actuators. In a fourth example that may include one or more of the first through third examples, the system further comprises additional instructions to activate the electrically driven pump in response to a pressure estimate that is based on output of the volume model for the accumulator. In a fifth example that may include one or more of the first through fourth examples, the system further comprises additional instructions to adjust a speed of the electrically driven pump to a threshold speed. In a sixth example that may include one or more of the first through fifth examples, the system further comprises additional instructions to deactivate the electrically driven pump in response to an amount of electric current delivered to the electrically driven pump.

Turning now to FIG. 4, a plot 400 of a relationship between electrically driven pump torque (Newton-meters (Nm)) and accumulator pressure (bar) is shown. The vertical axis represents pump torque and pump torque increases in the direction of the vertical axis arrow. The horizontal axis represents accumulator pressure and accumulator pressure increases in the direction of the horizontal axis arrow. Solid line 402 shows the relationship between electrically driven pump torque and pressure in the accumulator (e.g., 304 of FIG. 3).

Pressures in the accumulator may be less reliable between p0 and p1. Pressures within the accumulator between p1 and p2 may be more accurate and repeatable for a particular fluid temperature. The pump torque reaches a maximum near pressure p2, so pressures above p2 are not used via the system.

Referring now to FIG. 5, an example operating sequence that may be provided via the system of FIGS. 1A-3 in cooperation with the method of FIG. 6 is shown. In particular, FIG. 6 shows an example operating sequence where an accumulator pressure sensor changes from a non-degraded state to a degraded state. The plots of FIG. 5 are aligned in time and occur at the same time.

The first plot from the top of FIG. 5 is a plot of accumulator pressure versus time. The accumulator pressure may be measured or estimated. The vertical axis represents accumulator pressure and accumulator pressure increases in the direction of the vertical axis arrow. The horizontal axis represents time and time increases from the left side of the plot to the right side of the plot.

The second plot from the top of FIG. 5 is a plot of electrically driven pump speed versus time. The vertical axis represents electrically driven pump speed and electrically driven pump speed increases in the direction of the vertical axis arrow. The horizontal axis represents time and time increases from the left side of the plot to the right side of the plot.

The third plot from the top of FIG. 5 is a plot of pump torque versus time. The vertical axis represents pump torque and pump torque increases in the direction of the vertical axis arrow. The horizontal axis represents time and time increases from the left side of the plot to the right side of the plot. A threshold pump torque 550 represented as a dashed line is indicative of a requested pressure in the accumulator being reached when the accumulator pressure sensor is degraded (e.g., the sensor is not outputting a signal or value that is indicative of actual pressure in the accumulator).

At time t0, the accumulator pressure sensor is operating as expected. Therefore, the electrically driven pump is activated and deactivated according to output from the accumulator pressure sensor. In particular, the electrically driven pump is activated and it is commanded to a first speed at a first rate of speed change in response to accumulator pressure being less than a threshold pressure. Once speed of the electrically driven pump reaches the first speed, the electrically driven pump speed is reduced at a predetermined rate. The electrically driven pump is commanded off when the accumulator pressure reaches a first threshold pressure.

At time t1, pressure in the accumulator as measured by a pressure sensor is less than a minimum pressure threshold (not shown). Therefore, the electrically driven pump is activated and its speed is increased at a first ramping rate. The torque of the electrically driven pump increases as pump speed increases and as the accumulator is filled with fluid. The pressure in the accumulator also begins to build. Between time t1 and time t2, the pressure in the accumulator reaches a maximum pressure threshold. Therefore, the electrically actuated hydraulic pump is deactivated and the pressure in the accumulator begins to decline after reaching a peak.

At time t2, the pressure sensor reading accumulator pressure becomes degraded. Therefore, a time based accumulator pressure model or a volume based accumulator pressure model may activated for estimating pressure in the accumulator. In this example, a time based model is applied to estimate the accumulator pressure.

The most recent valid accumulator pressure value is applied to seed the initial conditions of the time based model. Pressure in the accumulator is adjusted as a function of time and operating state of the electrically driven pump. The electrically driven pump may be activated when the time based pressure in the accumulator is less than the minimum accumulator threshold value. The speed of the electrically driven pump is increased at a second rate that is slower than the rate hydraulic pump speed is ramped when the accumulator pressure sensor is not degraded. In addition, the speed of the electrically driven pump is increased to a second speed that is lower than the speed that the electrically driven pump is increased to when the accumulator pressure sensor is not degraded. Lowering the speed target and the rate of speed increase may help to reduce a possibility of rapid changes in electric current that is supplied to the electrically driven pump so that a possibility of spiking electric current and hydraulic pump torque may be avoided.

At time t3, the estimated pressure in the accumulator is less than the minimum threshold accumulator pressure, so the electrically driven pump is activated and its speed is ramped to the second threshold speed. The electrically driven pump is deactivated when the electrically driven pump torque is greater than threshold pump torque 550, the electrically driven pump is deactivated to conserve energy and avoid over pressure conditions. Between time t2 and time t4, the electrically driven pump is cycled on and off several times according to the estimated pressure in the accumulator.

At time t4, an accumulator volume based pressure estimate for the accumulator is activated and the time based estimate of accumulator pressure is deactivated. The accumulator volume based pressure estimate initial pressure is seeded with the most recent accumulator pressure estimate from the time based accumulator pressure estimate. The volume value of the accumulator volume based pressure estimate (e.g., the estimated volume of fluid in the accumulator) may decrease due to hydraulic actuator actuation and leakage of valves and seals. The volume value of the accumulator volume based pressure estimate may also increase with the volume of fluid that is pumped to the accumulator via the electrically actuated hydraulic pump.

At time t5, the accumulator pressure estimate from the accumulator volume based pressure estimate is reduced to a minimum pressure that causes the electrically driven pump to be activated. The electrically driven pump increases its speed at the second rate as it moves to the second requested pump speed. The torque of the electrically driven pump begins to increase shortly after time t5. Once the torque of the electrically driven pump reaches threshold pump torque 550, the electrically driven pump is deactivated to maintain system efficiency and reduce a possibility of over pressure conditions.

In this way, an estimate of pressure in an accumulator may be determined according to a time based model or volume based model. Pressure in the accumulator is controlled via activating and deactivating the electrically driven pump in response to accumulator pressure estimates. Thus, hydraulic systems may be supplied with fluid so that they may continue operating and move to an orderly shutdown.

Referring now to FIG. 6, a flowchart of a method 600 for operating a hydraulic system having an accumulator pressure sensor is shown. The method of FIG. 6 may be incorporated into and may cooperate with the system of FIGS. 1A-3. Further, at least portions of the method of FIG. 6 may be incorporated as executable instructions stored in non-transitory memory of a computing system (e.g., controller 212) while other portions of the method may be performed via the computing system transforming operating states of devices and actuators in the physical world. The method of FIG. 6 may be executed via a controller at predetermined time intervals (e.g., 10 milliseconds).

At 602, method 600 adjusts electrically driven pump output (e.g., flow) to achieve a requested pressure in an accumulator of a hydraulic system. In one example, the electrically driven pump is deactivated when pressure in the accumulator is greater than or equal to the requested pressure in the accumulator. The electrically driven pump is reactivated in response to pressure in the accumulator being less than a threshold pressure as shown in FIG. 5. The speed of the electrically driven pump may be increased to a first rate of speed change and the electrically driven pump speed may be increased to a first speed when the electrically driven pump is activated. The pressure in the accumulator is determined via a pressure sensor (e.g., 360 of FIG. 3). Method 600 proceeds to 604.

At 604, method 600 judges whether or not the pressure sensor is degraded. In one example, method 600 may judge that the pressure sensor is degraded if a pressure indicated by the pressure sensor is out of a predetermined pressure range. Method 600 may also judge that the pressure sensor is degraded if the pressure sensor does not respond with a pressure reading in an expected way. For example, if the electrically activated hydraulic pump is activated and supplying fluid to the accumulator, it may be expected that accumulator pressure will rise. If accumulator pressure does not rise as expected, method 600 may judge that the pressure sensor is degraded. If method 600 judges that the pressure sensor is degraded, the answer is yes and method 600 proceeds to 606. Otherwise, the answer is no and method 600 returns to 602.

At 606, method 600 judges whether accumulator pressure sensor mitigation is enabled. In one example, method 600 may judge that accumulator pressure sensor mitigation is or is not enable according to a value of a variable that is stored in controller memory. If method 600 judges that accumulator pressure sensor mitigation is enabled, the answer is yes and method 600 proceeds to 608. Otherwise, the answer is no and method 600 proceeds to 620.

At 620, method 600 deactivates the electrically driven pump so that hydraulic charging of the hydraulic system ceases. Further, method 600 may notify a machine operator that the hydraulic system is being shut down via a message to a human/machine interface. Method 600 proceeds to exit.

At 608, method 600 retains a last most recent pressure value from the pressure sensor that became degraded and stores the pressure value to memory. Method 600 proceeds to 610.

At 610, method 600 converts the last most recent pressure value from the pressure sensor to a volume value for fluid that is stored in the accumulator. In one example, method 600 may reference a table or function (e.g., 700 in FIG. 7) stored in controller via fluid pressure in the accumulator and the temperature of the fluid in the accumulator. The table or function outputs a volume of fluid stored in the accumulator. Values in the table or function may be empirically determined via monitoring pressure in the accumulator while increasing the volume of fluid in the accumulator and the temperature of the fluid in the accumulator. Method 600 may also adjust the volume estimate of fluid that is stored in the accumulator according to a leakage volume and volume loss due to actuating a hydraulic actuator (e.g., a cylinder or clutch). The volume of fluid stored in the accumulator may be estimated via the following equation:

$$EHAV = hav ( acctemp , accpres ) - havl ( Fflow , acctemp ) - haval ( Estflow , acctemp )$$

where EHAV is the estimated fluid volume in the accumulator, hav is a function (e.g., a model) that returns the fluid volume stored in the accumulator, acctemp is temperature of the fluid being stored in the accumulator, accpress is pressure of the fluid being stored in the accumulator, hav1 is a function that returns an accumulator volume loss due to leakage during one execution cycle of method 600, Fflow is the estimated leakage flow rate, this flow rate is dependent on the fluid temperature. Hava1 is a function that returns a fluid volume loss in the accumulator due to actuation of a hydraulic actuator during one execution cycle (e.g., 10 milliseconds) of method 600, Estflow is the estimated flow rate into the actuator piston estimated, this flow rate is dependent on the fluid temperature and what actuators are currently being controlled by the application. Once the estimated volume of fluid stored in the accumulator is determined, it is converted to a pressure value (e.g., a new value for accpres) via referencing a function or table (e.g., 700 of FIG. 7) according to the pressure of fluid stored in the accumulator and temperature of the fluid that is stored in the accumulator. Method 600 proceeds to 612 after pressure of fluid stored in the accumulator is determined.

At 612, method 600 judges whether or not pressure of the fluid in the accumulator as determined at step 610 is greater than a threshold pressure. If so, the answer is yes and method 600 proceeds to 614. Otherwise, the answer is no and method 600 returns to 610 where the volume and pressure is recalculated.

At 614, method 600 activates the electrically driven pump and increases the rate of speed change at a second rate, the second rate less than the first rate when pump speed is increased when the pressure sensor is not degraded. Method 600 also adjusts the speed of the electrically driven pump to a second speed, the second speed less than the first speed. Increasing the speed of the electrically driven pump increases the charge in the accumulator by adding additional fluid to the accumulator.

To ensure a more accurate line pressure is reported back to the rest of the application method 600 also estimates the increase in volume of fluid stored in the accumulator by the electrically driven pump. In one example, method 600 estimates the volume increase of fluid stored in the accumulator according to electrically driven pump operating conditions (e.g., speed, temperature, etc.). In one example, method 600 estimates the volume of increase in fluid stored in the accumulator according to the following equation:

ΔAV=p(acctemp,n,dt)

where ΔAV is the change in volume of fluid added to the accumulator, p is a function that returns the volume, acctemp is temperature of the fluid being stored in the accumulator, n is the rotational speed of the electrically driven pump, and dt is the time interval between executions of method 600. The function p may be an equation or a table stored in controller memory that is filled with empirically determined volume values.

Method 600 also monitors electrically driven pump torque. In one example, the amount of electric current flowing to the electrically driven pump is converted into a torque output value for the electrically driven pump via the following equation:

EPT=g(pumcur,pumtem,n)

where EPT is the electrically driven pump torque, g is a function (e.g., FIG. 8) that returns the electrically driven pump torque, pumcur is the amount of electric current that is going into the electrically driven pump, pumtem is the electrically driven pump temperature, and n is the rotational speed of the electrically driven pump. Method 600 proceeds to 616 and 622.

At 622, method 600 judges whether or not an amount of time to recharge the accumulator is greater than a threshold amount of time. In one example, method 600 may track the most recent amount of time that the electrically driven pump has been continuously activated to determine the amount of time recharging the accumulator has been active. If method 600 judges that recharging of the accumulator has been active for longer than a threshold amount of time, the answer is yes and method 600 proceeds to 620. Otherwise, the answer is no and method 600 returns to 614.

At 616, method 600 judges whether or not torque output of the electrically driven pump exceeds a threshold amount of torque for longer than a threshold amount of time. If so, the answer is yes and method 600 proceeds to 618. Otherwise, the answer is no and method 600 returns to 614.

At 618, method 600 ceases electric current flow to the electrically driven pump, thereby deactivating the pump. Method 600 also opens the charging valve (e.g., 310 of FIG. 3) to decouple the electrically driven pump from the accumulator. Method 300 also adjusts the estimate of pressure in the accumulator to a predetermined value (e.g., 31 bar). The predetermined pressure is based on an empirically determined relationship between electrically driven pump torque and accumulator pressure. Method 600 returns to 610 where the pressure may be converted into a volume of fluid stored in the accumulator for use by the accumulator volume model.

In this way, when a pressure sensor of a hydraulic system is degraded, a volume of fluid stored in an accumulator may be adjusted for fluid consumption and leaks. The volume of fluid may be converted into an estimated pressure value for fluid in the accumulator and an electrically driven pump may be activated and deactivated according to the estimated pressure value for the fluid.

Thus, the method of FIG. 6 provides for a method for operating a hydraulic system, comprising: adjusting operation of a pump in response to output of a pressure sensor that indicates pressure in an accumulator; and adjusting operation of the pump in response to an amount of electric current delivered to the pump and an indication of degradation of the pressure sensor. In a first example, the method includes where adjusting operation of the pump in response to the pressure sensor includes adjusting pump speed to a first threshold speed. In a second example that may include the first example, the method includes where adjusting operation of the pump in response to the pressure sensor includes adjusting a rate of change of pump speed to a first rate of change. In a third example that may include one or both of the first and second examples, the method includes where adjusting operation of the pump in response to the amount of electric current delivered to the pump and the indication of degradation of the pressure sensor includes adjusting pump speed to a second threshold speed, the second threshold speed lower than the first threshold speed. In a fourth example that may include one or more of the first through third examples, the method includes where adjusting operation of the pump in response to the amount of electric current delivered to the pump and the indication of degradation of the pressure sensor includes adjusting the rate of change of pump speed to a second rate of change, the second rate of change less than the first rate of change. In a fifth example that may include one or more of the first through fourth examples, the method includes where adjusting operation of the pump in response to the amount of electric current delivered to the pump and the indication of degradation of the pressure sensor includes stopping the pump in response to electric current flow to the pump exceeding a threshold. In a sixth example that may include one or more of the first through fifth examples, the method further comprises closing a charging valve to direct flow of a fluid from the pump to the accumulator in response to an estimate of pressure within the accumulator being less than a threshold pressure. In a seventh example that may include one or more of the first through sixth examples, the method further comprises deactivating the pump in response to a charging time being longer than a threshold amount of time, and where the charging time is an amount of time beginning at a time when the charging valve was most recently closed to a time when the estimate of pressure exceeds a threshold pressure.

The method of FIG. 6 also provides for a method for operating a hydraulic system, comprising: adjusting operation of a pump in response to output of a pressure sensor that indicates pressure in an accumulator; and adjusting operation of the pump in response to a pressure estimate based on a volume of fluid stored in an accumulator. In a first example, the method includes where adjusting operation of the pump in response to the pressure estimate based on the volume of fluid stored in the accumulator includes activating the pump. In a second example that may include the first example, the method includes where the volume of fluid stored in the accumulator is adjusted according to a fixed volume decay rate. In a third example that may include one or both of the first and second examples, the method includes where the volume of fluid stored in the accumulator is adjusted according to actuation of an actuator. In a fourth example that may include one or more of the first through third examples, the method further comprises deactivating the pump in response to an amount of current supplied to the pump.

Referring now to FIG. 7, a plot that shows a relationship between a volume of a fluid stored in a hydraulic accumulator and a pressure of the fluid that is stored in the hydraulic accumulator is shown. The relationship may be stored in an array of memory cells of a controller and the relationship may be indexed or referenced via temperature and volume of the fluid or via temperature and pressure of the fluid.

Plot 700 includes a vertical axis that represents volume of a fluid stored in a hydraulic accumulator and the volume increases in the direction of the vertical axis arrow. Plot 700 also includes a horizontal axis that represents pressure of fluid that is stored in the hydraulic accumulator and the pressure increases in the direction of the horizontal axis arrow. Plot 700 also includes a lateral axis that represents a temperature of the fluid that is stored in the hydraulic accumulator and the temperature increases in the direction of the lateral axis arrow. Surface 702 represents the relationship between volume of hydraulic fluid in the accumulator, pressure of fluid in the accumulator, and temperature of fluid in the accumulator.

Referring now to FIG. 8, a plot that shows a relationship between motor current, motor torque, and temperature of fluid in the accumulator is shown. The relationship may be stored in an array of memory cells of a controller and the relationship may be indexed or referenced via temperature and volume of the fluid or via temperature and pressure of the fluid.

Plot 800 includes a vertical axis that represents motor electric current (e.g., electric current consumed by the motor) for the electrically driven hydraulic pump and the motor current increases in the direction of the vertical axis arrow. Plot 800 also includes a horizontal axis that represents motor torque for the electrically driven hydraulic pump and the motor torque increases in the direction of the horizontal axis arrow. Plot 800 also includes a lateral axis that represents a temperature of the fluid that is stored in the hydraulic accumulator and the temperature increases in the direction of the lateral axis arrow. Surface 802 represents the relationship between motor current, motor torque, and temperature of fluid in the accumulator.

Note that the example control and estimation routines included herein can be used with various vehicle or machine system configurations. The control methods and routines disclosed herein may be stored as executable instructions in non-transitory memory and may be carried out by the control system including the controller in combination with the various sensors, actuators, and other machine hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to cranes, excavators, scrapers, and other systems that include linked or coupled components.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a hydraulic system, comprising:
adjusting operation of a pump in response to output of a pressure sensor that indicates pressure in an accumulator; and
adjusting operation of the pump in response to an amount of electric current delivered to the pump and an indication of degradation of the pressure sensor.

2. The method of claim 1, where adjusting operation of the pump in response to the pressure sensor includes adjusting pump speed to a first threshold speed.

3. The method of claim 2, where adjusting operation of the pump in response to the pressure sensor includes adjusting a rate of change of pump speed to a first rate of change.

4. The method of claim 3, where adjusting operation of the pump in response to the amount of electric current delivered to the pump and the indication of degradation of the pressure sensor includes adjusting pump speed to a second threshold speed, the second threshold speed lower than the first threshold speed.

5. The method of claim 4, where adjusting operation of the pump in response to the amount of electric current delivered to the pump and the indication of degradation of the pressure sensor includes adjusting the rate of change of pump speed to a second rate of change, the second rate of change less than the first rate of change.

6. The method of claim 1, where adjusting operation of the pump in response to the amount of electric current delivered to the pump and the indication of degradation of the pressure sensor includes stopping the pump in response to electric current flow to the pump exceeding a threshold.

7. The method of claim 6, further comprising closing a charging valve to direct flow of a fluid from the pump to the accumulator in response to an estimate of pressure within the accumulator being less than a first threshold pressure.

8. The method of claim 7, further comprising deactivating the pump in response to a charging time being longer than a threshold amount of time, and where the charging time is a time duration beginning when the charging valve was most recently closed and ending when the estimate of pressure exceeds a second threshold pressure.

9. A hydraulic system, comprising:
one or more hydraulic actuators;
an electrically driven pump;
an accumulator, the accumulator hydraulically selectively coupled to the one or more hydraulic actuators and the electrically driven pump;
a pressure sensor; and
a controller including a non-transitory computer readable medium having executable instructions that cause the controller to adjust operation of the electrically driven pump in response to output of the pressure sensor during a first condition and adjust operation of the electrically driven pump in response to a pressure estimate based on a volume model for the accumulator during a second condition.

10. The hydraulic system of claim 9, where the first condition is where the pressure sensor is not degraded, and where the second condition is where the pressure sensor is degraded.

11. The hydraulic system of claim 10, where the volume model includes a fixed volume decay rate.

12. The hydraulic system of claim 11, further comprising one or more hydraulic actuators, and where the volume model compensates for actuation of one or more hydraulic actuators.

13. The hydraulic system of claim 12, further comprising additional instructions to activate the electrically driven pump in response to the pressure estimate that is based on output of the volume model for the accumulator.

14. The hydraulic system of claim 13, further comprising additional instructions to adjust a speed of the electrically driven pump to a threshold speed.

15. The hydraulic system of claim 14, further comprising additional instructions to deactivate the electrically driven pump in response to an amount of electric current delivered to the electrically driven pump.

16. A method for operating a hydraulic system, comprising:
adjusting operation of a pump in response to output of a pressure sensor that indicates pressure in an accumulator; and
adjusting operation of the pump in response to a pressure estimate based on a volume of fluid stored in the accumulator.

17. The method of claim 16, where adjusting operation of the pump in response to the pressure estimate based on the volume of fluid stored in the accumulator includes activating the pump.

18. The method of claim 17, where the volume of fluid stored in the accumulator is adjusted according to a fixed volume decay rate.

19. The method of claim 18, where the volume of fluid stored in the accumulator is adjusted according to actuation of an actuator.

20. The method of claim 19, further comprising deactivating the pump in response to an amount of current supplied to the pump.
